(19) United States
(12) Patent Application Publication
(10) Pub. No.: US 2013/0144749 A1
(43) Pub. Date: Jun. 6, 2013

(54) SUPPLIER RATING AND REPORTING

(71) Applicant: MARTINA ROTHLEY, Schwetzingen (DE)

(72) Inventor: MARTINA ROTHLEY, Schwetzingen (DE)

(21) Appl. No.: 13/310,805

(22) Filed: Dec. 5, 2011

(51) Int. Cl. G06Q 30/00

(52) U.S. Cl. 705/26.7

(57) ABSTRACT

Various embodiments of systems and methods for supplier rating and reporting are described herein. A first user interface is provided to a purchaser in response to a selection. The first user interface comprises one or more supplier analysis options. In response to selection of one or more of the options on the first user interface, a supplier rating analysis is generated and displayed using supplier evaluation data provided by a plurality of purchasers and stored in a data source. Based on a purchasing activity, a second user interface is provided to the purchaser. The second user interfaces comprises one or more input fields to capture the evaluation data from the purchaser. The input fields comprise supplier rating-level fields and supplier rating-criteria fields. The evaluation data is received after input by the purchaser. The evaluation data received from the purchaser is stored in the data source.

### FIELD

The field relates generally to computer-implemented rating methods. More particularly, the field relates to ad hoc supplier rating and reporting.

### BACKGROUND

Supplier evaluation is crucial in reducing risks associated with suppliers. Purchasers typically require evaluation or rating information about suppliers before making purchase decisions. Supplier evaluation is also useful from the point of view of a supplier. Supplier evaluation reports enable suppliers to understand their performance and make any necessary improvements. As part of a supplier evaluation process, information about a supplier is collected in an effort to understand the performance of the supplier. One of the usual ways of collecting such information is through questionnaires. Questionnaires are created and distributed among a group of individuals such as purchasing department personnel or personnel who requested a purchase. The questionnaires include various evaluation or rating criteria. The completed questionnaires are then used to analyze the performance of a supplier.

This process of collecting information about suppliers may be automated using supplier evaluation tools. But such supplier evaluation tools typically require various setup operations such as setting up of evaluation criteria, setting access controls for viewing supplier rating data, etc., making their usage cumbersome. Moreover, such supplier evaluation tools may not be available to all individuals who are involved in a purchasing activity workflow or a sales activity workflow. Therefore, some individuals, despite having a need, may not be able to participate in supplier rating or view supplier ratings due to complexities of the evaluation tools.

It would therefore be desirable to provide an intuitive and easily accessible method for rating suppliers and viewing supplier ratings.

### SUMMARY

Various embodiments of systems and methods for supplier rating and reporting are described herein. A first user interface is provided to a purchaser in response to a selection. The first user interface comprises one or more supplier analysis options. In response to selection of one or more of the options on the first user interface, a supplier rating analysis is generated and displayed using supplier evaluation data provided by a plurality of purchasers and stored in a data source. Based on a purchasing activity, a second user interface is provided to the purchaser. The second user interface comprises one or more input fields to capture the evaluation data from the purchaser. The input fields comprise supplier rating-level fields and supplier rating-criteria fields. The evaluation data is received after input by the purchaser. The evaluation data received from the purchaser is then stored in the data source.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 illustrates an embodiment of a method for supplier rating and reporting.

FIG. 2 illustrates a social networking webpage of a purchaser, according to one embodiment.

FIGS. 3-5 illustrate first user interfaces including supplier rating analyses, according to one embodiment.

FIG. 6 illustrates a table of a supplier rating analysis, according to one embodiment.

FIG. 7-9 illustrate user interfaces related to various purchasing activities, according to one embodiment.

FIGS. 10-11 illustrate second user interfaces for capturing supplier ratings, according to one embodiment.

FIGS. 12-13 illustrate second user interfaces for capturing supplier ratings, according to another embodiment.

FIG. 14 illustrates a social networking webpage of a supplier, according to one embodiment.

FIG. 15 illustrates a third user interface including supplier rating analysis, according to one embodiment.

FIG. 16 illustrates a framework of the supplier rating and reporting method, according to one embodiment.

FIG. 17 is a block diagram of an exemplary computer system according to one embodiment.

### DETAILED DESCRIPTION

Embodiments of techniques for supplier rating and reporting are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

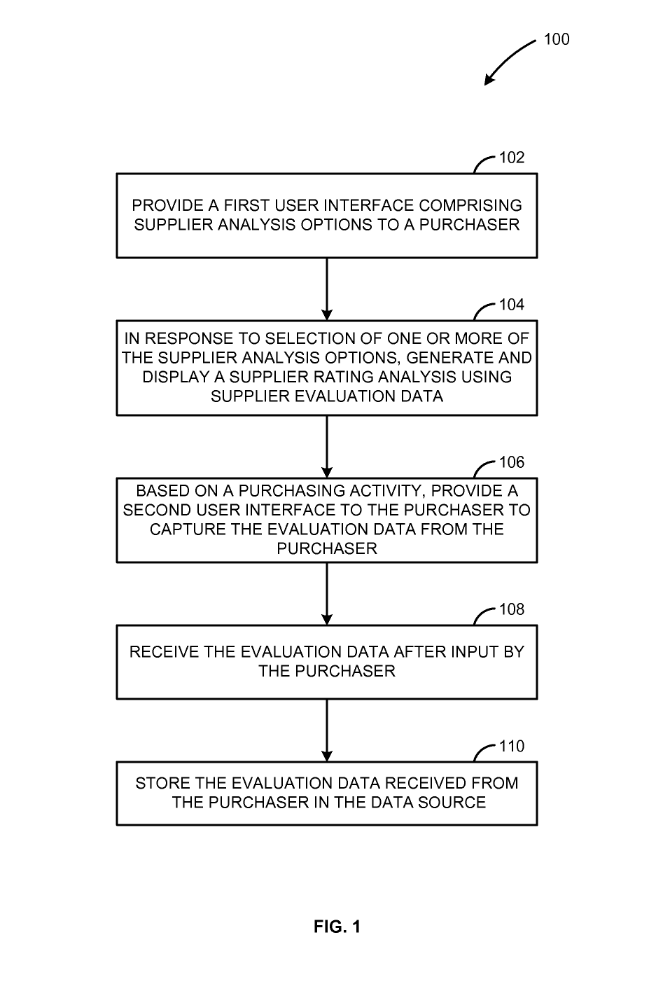

FIG. 1 illustrates an embodiment of a method for supplier rating and reporting 100. The method provides easy access to purchasers to participate in supplier rating and view a variety of supplier rating reports. A purchaser can be any user involved in a purchasing process. A purchasing process includes several purchasing activities such as buying decision, purchase order creation, invoicing, etc. There can be more than one user involved in each of the purchasing activities. At 102, a first user interface is provided to a purchaser in response to a selection. In one embodiment, a link to the first user interface is provided in software applications that are typically used by the purchasers within an organization. A purchaser can log on to the software application and provide details about purchase, create invoices, etc. Such software applications are available internally, over Intranet, to purchase department employees of an organization. In another embodiment, purchasers can have access to Extranet. Purchasers of an organization and suppliers associated with or authorized by that organization can be linked via the Extranet. Purchasing process-related software applications are available over the Extranet to purchasers of the organization and the suppliers for that organization. A link can be provided in such software applications and the first user interface is provided in response to selection of the link.

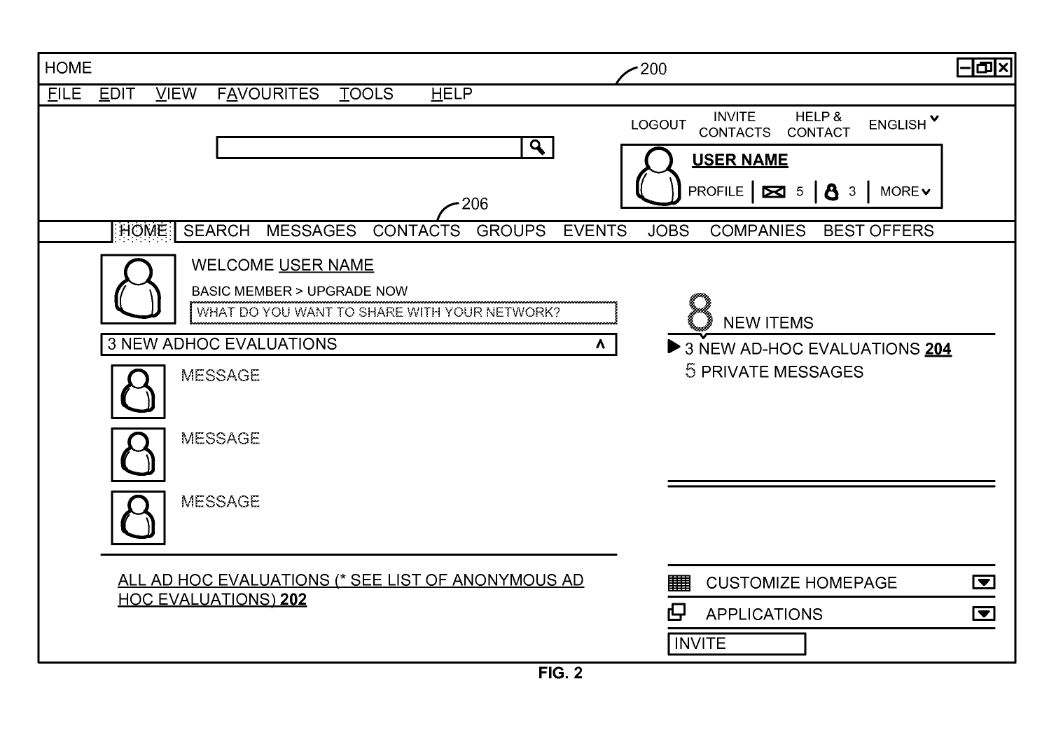

Referring to FIG. 2, in another embodiment, a link to the first user interface is published in a social networking website 200. It has become common for purchasers and suppliers to use social networking as a platform to communicate more effectively. A purchaser can have an account in a social networking website 200. A supplier or supplier-side user can also have an account in the social networking website 200. The purchaser can form a community or a group including suppliers and several other purchasers. A purchaser can invite suppliers and other purchasers to join a group. A supplier or other purchasers can request access to a group to be part of that group. One or more links 202 and 204 to the first user interface are published on a social networking webpage 206 of a purchaser. Following selection of a link 202 or 204, the first user interface is provided to the purchaser.

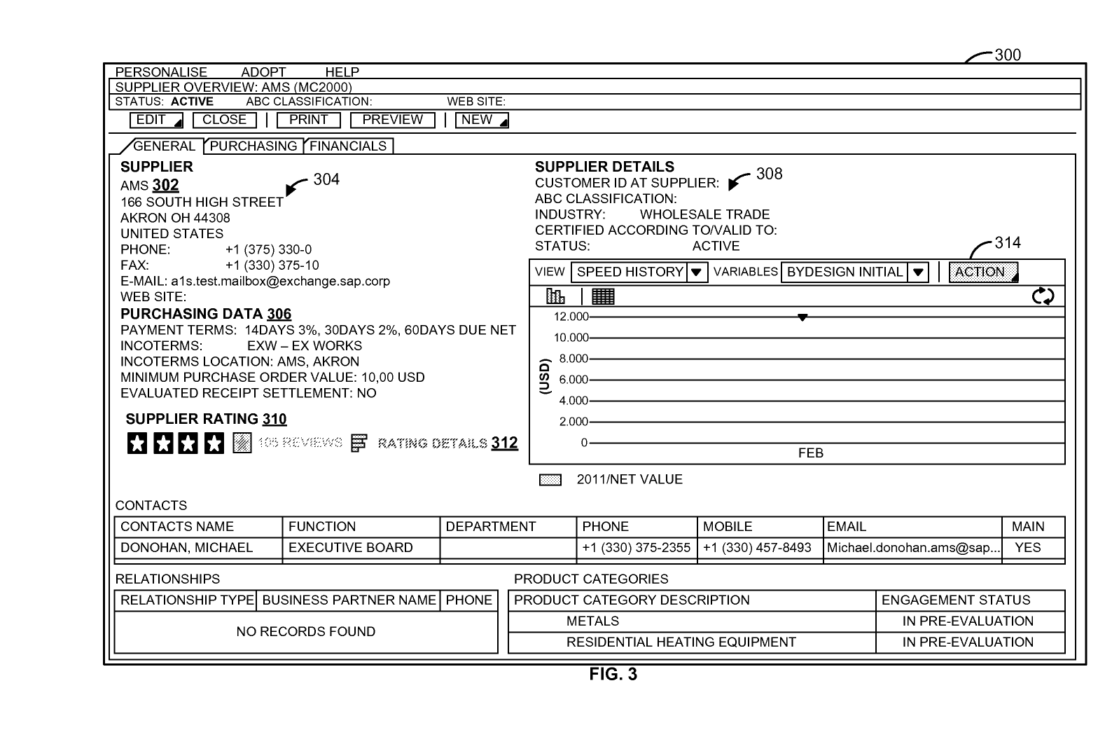

Referring to FIG. 3, the first user interface 300 includes several options to analyze a supplier in terms of performance. The first user interface includes details of a supplier such as supplier name 302, address 304, purchase-related data 306, and other supplier details 308. The first user interface 300 also includes average rating 310 of the supplier on a rating scale. Supplier analysis options can be presented in a variety of formats. In one embodiment, options are provided as links, such as the “Rating Details” option 312. In another embodiment, the options can be provided in association with a graph 314 displayed on the first user interface 300.

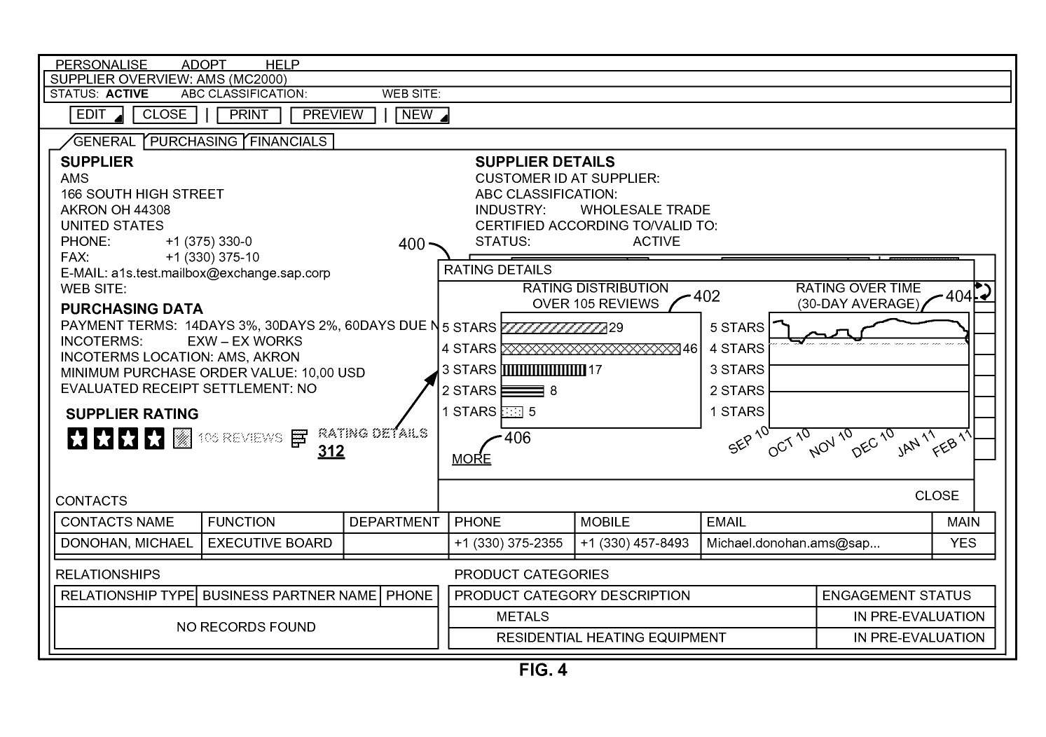

Referring back to FIG. 1, after an option on the first user interface is selected a supplier rating analysis is generated using supplier evaluation data and displayed to the purchaser at 104. The evaluation data is provided by a plurality of purchasers. This evaluation data is stored in a data source. Following selection of an option, analytic operations can be performed using the stored data to generate a supplier rating analysis. In one embodiment, the supplier rating analysis is displayed through a pop-up window. For example, referring to FIG. 4, if the purchaser selects the “Rating Details” option 312, stored evaluation data is used to generate a supplier rating analysis 400. The supplier rating analysis 400 is displayed in a separate window over the first user interface. The supplier rating analysis 400 includes a Rating Distribution graph 402 and Rating over Time graph 404. In the Rating Distribution graph 402, the ratings are categorized into rating levels, i.e. number of stars. The length of a bar associated with a rating level represents the number of purchasers who gave that rating. In the Rating over Time graph 404, average rating per month for few months is presented. From the Rating over Time graph 404, the performance of the supplier over a period of time can be witnessed.

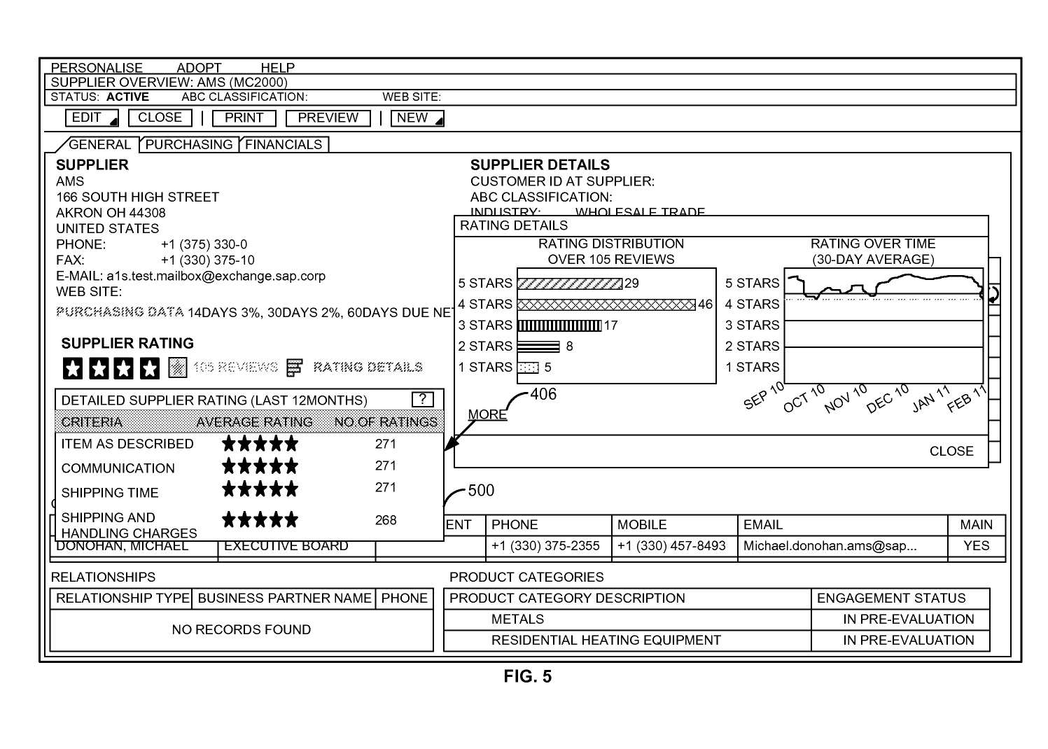

In one embodiment, the supplier rating analysis 400 can include drill down options. The drill down options can enable a purchaser to view more detailed analyses. Rating data stored in the data source is used for such detailed analyses. A drill down option can include, for example, a “More” option 406 to access in-depth rating details. A new supplier rating analysis 500 is provided when the “More” option 406 is selected, as shown in FIG. 5. The rating details include rating criteria, average ratings for each rating criterion, and number of ratings for each rating criterion. Rating criteria can include item conformity in relation to item/product description, communication, shipping time, and shipping and handling charges. Number of ratings for a criterion refers to the number of purchasers who provided ratings for that criterion.

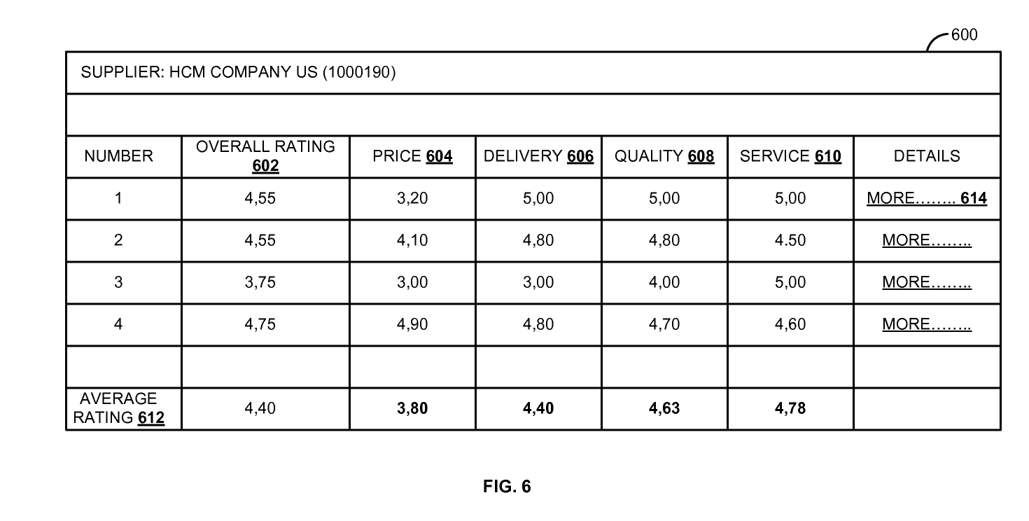

In one embodiment, the supplier rating analysis is provided in a tabular format 600, as shown in FIG. 6. The table 600 provides various rating details provided by four purchasers. The table includes overall ratings 602 and ratings for each rating criteria. The rating criteria include price 604, delivery 606, quality 608, and service 610. Average ratings 612 for the overall ratings and each rating criterion are also presented in the table. The table also includes a drill down option, i.e. a “More” option 614. Upon selection of the “More” option 614, a detailed analysis of ratings can be provided either in a graphical format or a tabular format. With the help of graphical and/or tabular supplier rating analyses described above, a purchaser can get a meaningful overview about the performance of a supplier. This information can be valuable for a purchaser before making any purchase decision.

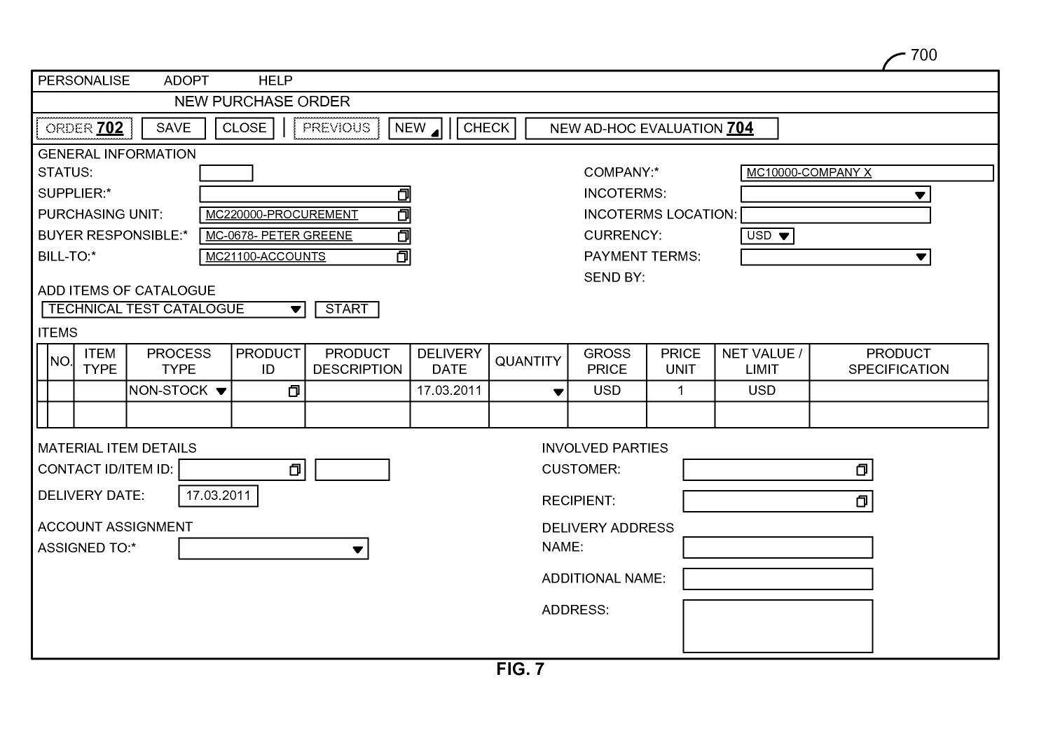

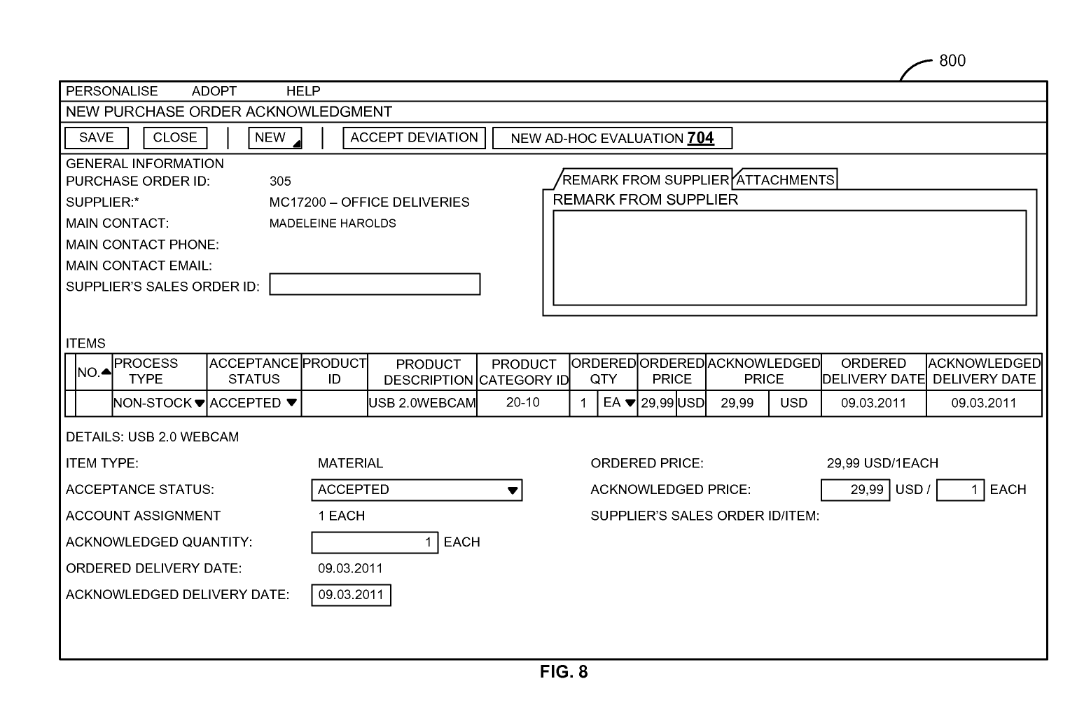

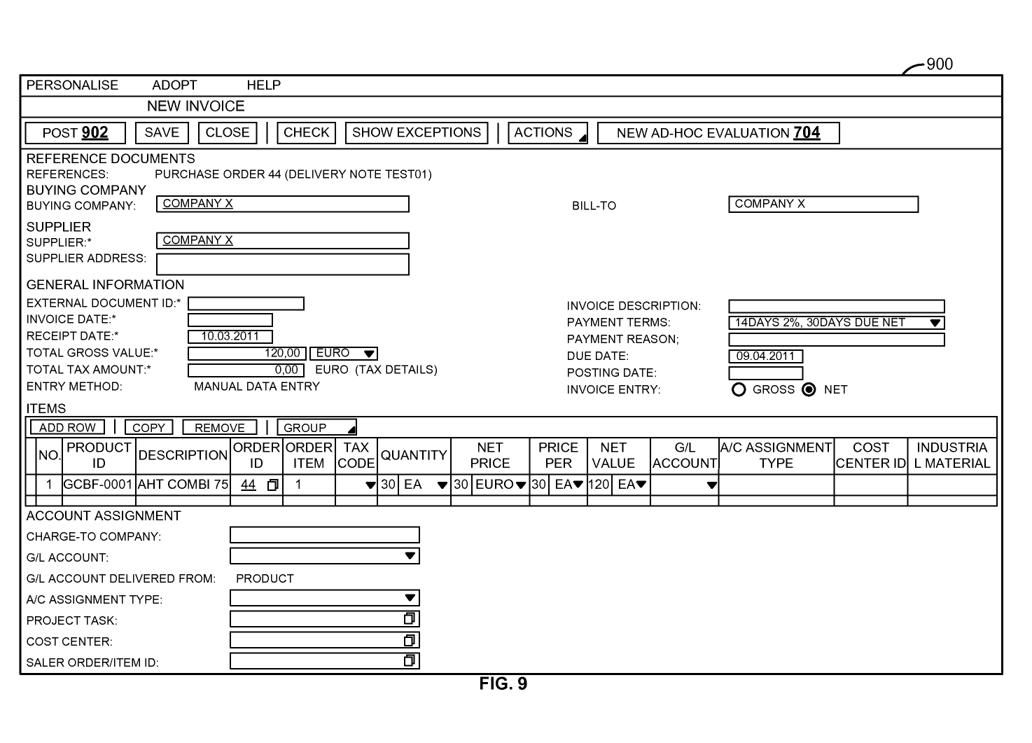

Referring back to FIG. 1, at 106, one or more second user interfaces is provided to the purchaser based on a purchasing activity. As mentioned previously, purchasers typically use software applications during a purchasing process. Different purchasing users have different roles and perform respective purchasing activities using such software applications. For example, a purchasing activity includes creation of a new purchase order. A screenshot of a user interface of a software application to create a new purchase order is shown in FIG. 7. A purchaser enters necessary details in various fields on the user interface 700, saves the data, and selects “order” tab 702 to create a purchase order. As another example, a purchasing activity includes receipt of purchase order acknowledgement. A screenshot of a user interface 800 of a software application for purchase order acknowledgement is shown in FIG. 8. The purchase order acknowledgement should be accepted before proceeding for the purchase. A purchasing activity can also include creation of a new invoice and posting of a goods and services receipt. A screenshot of a user interface 900 of a software application for creating a new invoice is shown in FIG. 9. A purchaser enters necessary details and selects “post” tab 902 to create the new invoice. It should be noted that different purchasing users may be involved in various purchasing activities based on their roles, such as those described above. For example, a first purchaser can create a purchaser order, a second purchaser can enter, accept or reject purchase order acknowledgement, and a third purchaser can create the invoice.

A purchaser accessing the software application during a purchasing process, as described in reference to FIGS. 7-9, is provided with an opportunity to rate a supplier. One or more second user interfaces are provided to the purchaser to capture evaluation data from that purchaser. In one embodiment, a second user interface is provided when the purchaser completes a respective purchasing activity on a user interface (e.g., FIG. 7-9). In another embodiment, an option or a button 704 is provided in a user interface (e.g., FIG. 7-9) of the software application to rate a supplier.

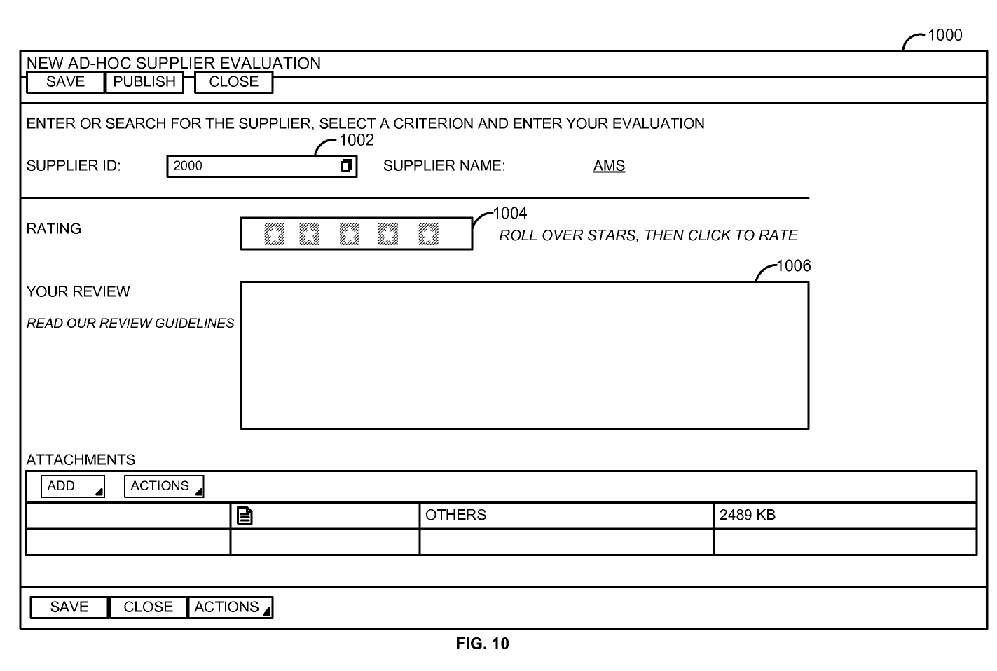

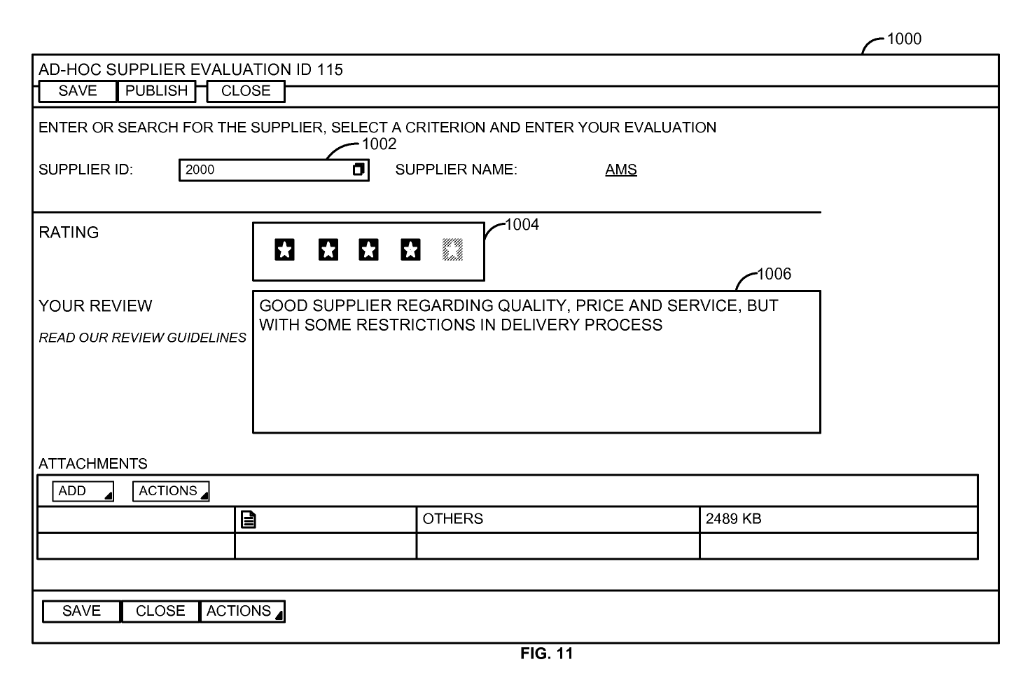

Referring to FIG. 10, a second user interface 1000 includes input fields to capture evaluation data. In one embodiment, the input fields include a supplier identification field 1002 and a rating-level field 1004. The purchaser can select or type a supplier identifier in the supplier identification field 1002. The rating-level field 1004 includes series of five stars. The purchaser needs to select a number of stars to rate the supplier. For example, the purchaser can roll over the stars and select to rate the supplier. If the purchaser rolls over the fourth star and selects it, the supplier is given a rating of four out of five. The second user interface also includes a review or comment section 1006. A purchaser can type any specific comments about the supplier in the review section 1006. The second user interface 1000 after entry in the input fields is shown in FIG. 11. The purchase can save the entry and publish the evaluation.

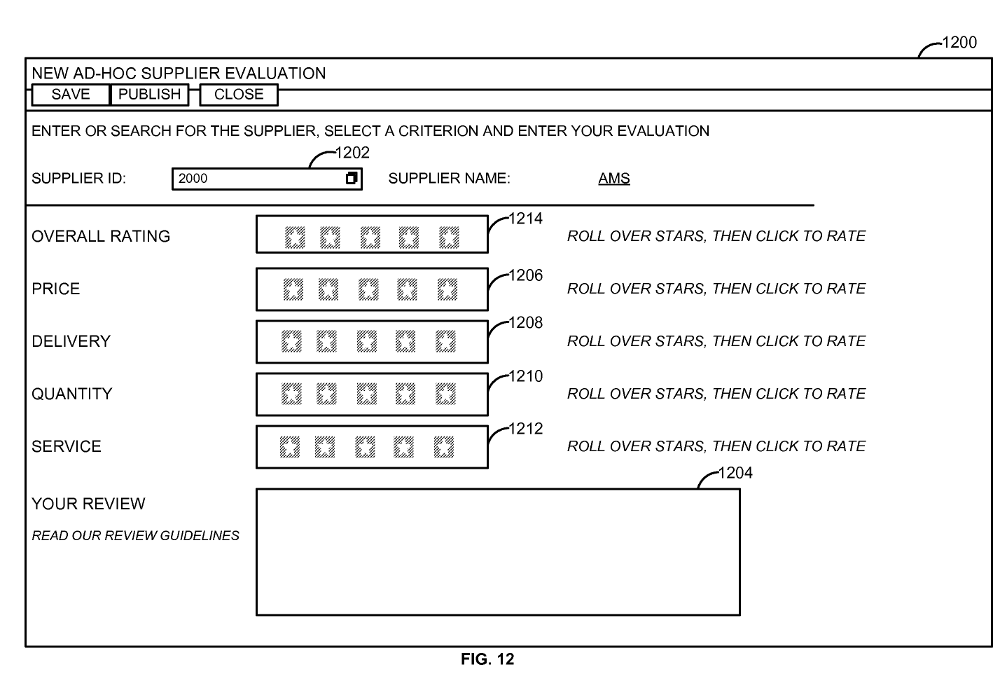

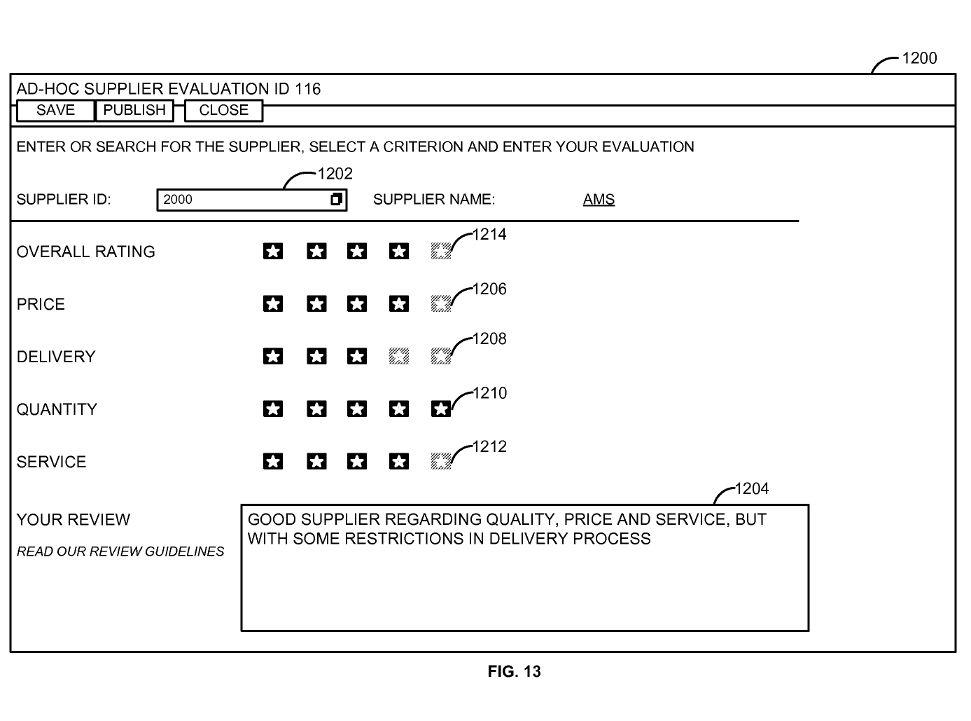

Another embodiment of the second user interface 1200 is shown in FIG. 12. The input fields of the second user interface 1200 include a supplier identification field 1202, a review section 1204, and a plurality of rating-level fields 1206, 1208, 1210, 1212, and 1214. Each rating-level field is associated with a rating criterion. The rating criteria include price, delivery, quantity, service, and overall rating. To assign a rating, the purchaser rolls over a star and selects it. The number of stars indicates the level of satisfaction with related to a particular rating criterion. The higher the number of stars for a rating criterion, the greater the purchaser satisfaction for that rating criterion. FIG. 13 illustrates this second user interface 1200 after entry in the input fields. The purchaser can then save and publish the evaluation data.

Referring back to FIG. 1, the evaluation data is received at 108 after input by the purchaser in the second user interface. Once the purchaser saves and publishes in the second user interface, the evaluation data is transmitted and received at a data source. The received evaluation data is stored in the data source at 110. Similarly, evaluation data from a plurality of purchasers is received and stored in the data source. The evaluation data includes the entries made by the purchasers in the input fields of the second user interface. These entries are stored in relation to respective input fields. This stored data is used for generating a variety of supplier rating analyses. Following selection of a supplier rating analysis option in the first user interface, the stored data is used to generate and display a graphical or a tabular rating analysis.

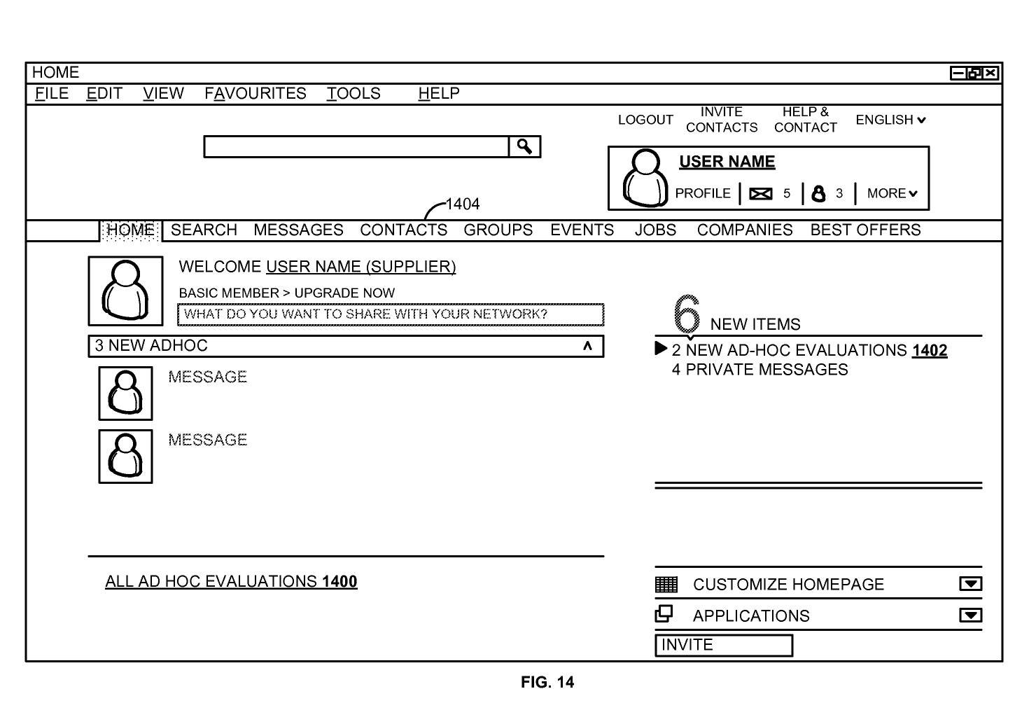

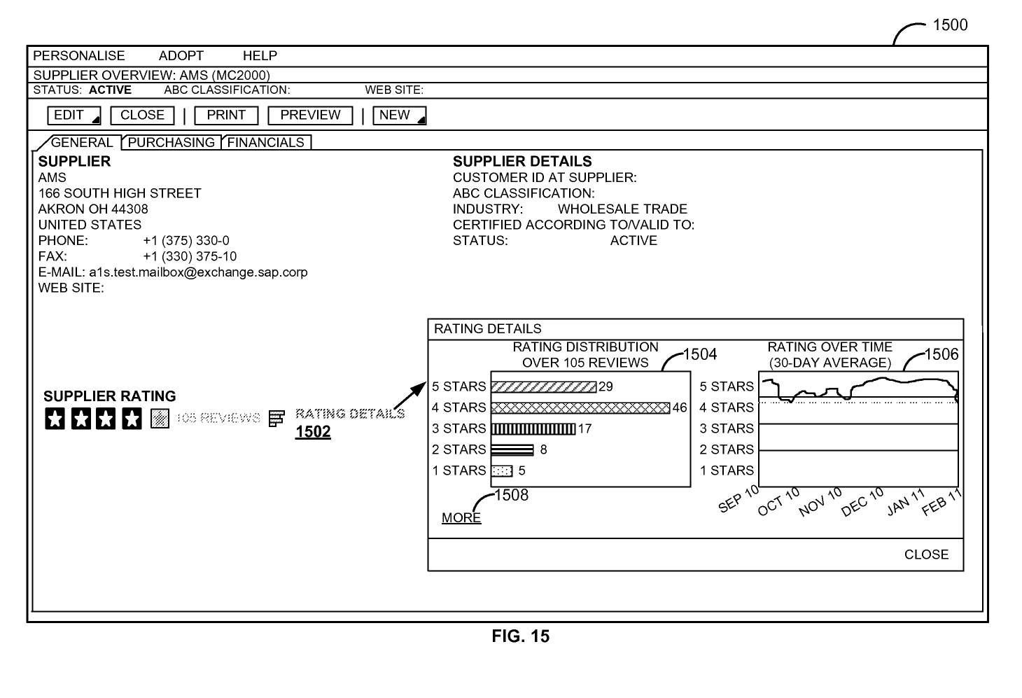

A supplier can also be provided access to supplier rating analyses. In one embodiment, one or more links 1400 and 1402 can be provided in a social networking webpage 1404 of a supplier or a supplier-side user, as shown in FIG. 14. Upon selection of a link 1400 or 1402, a third user interface is provided to the supplier. In another embodiment, the third interface can be made available to the supplier via an Extranet connecting the supplier with a plurality of purchasers. As shown in FIG. 15, the third user interface 1500 is similar to the first user interface and includes an option 1502 for generating supplier rating analysis. Following selection of the option 1502 by the supplier, the stored evaluation data is used to generate and display a graphical or a tabular analysis of supplier rating analysis. Analyses (tabular and/or graphical) similar to the ones generated and displayed in response to selection of an option in the first user interface can also be provided in response to selection of an option in the third user interface. For example, the Rating Distribution graph 1504 and Rating over Time graph 1506 can also be presented to the supplier. The supplier rating analyses provided to the supplier can also include drill down options, e.g., a “More” option 1508, to generate detailed analyses.

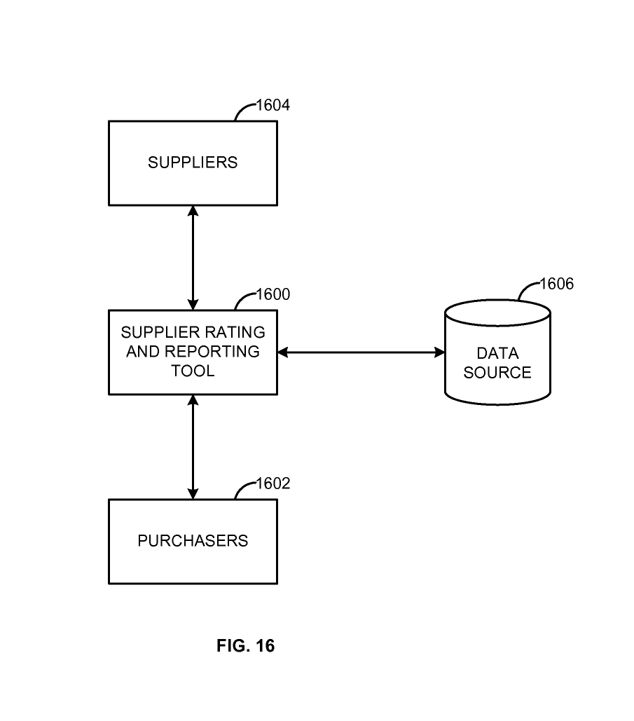

FIG. 16 illustrates a framework of the supplier rating and reporting method. The supplier rating and reporting tool 1600 includes the first, second, and third user interfaces, as described previously. The supplier rating and reporting tool 1600 can be made accessible to purchasers 1602 and suppliers 1604 over Internet, Intranet, or Extranet. The evaluation data provided by the purchasers is stored in a data source 1606. The data source 1606 can be a database. The data source 1606 can be interfaced with an enterprise or business software system such as an Enterprise Resource Planning (ERP) system or a Business Intelligence (BI) system. The evaluation data can be stored in an analysis-friendly format. For example, the evaluation data can be stored in a multi-dimensional format, which can be used by BI or On Line Analytic Processing (OLAP) tools to generate intuitive supplier rating reports.

The supplier rating and reporting method described above provides easy access to supplier rating and supplier rating analyses via the first user interface which can be used by many purchasers. Several users involved in a purchasing process and performing purchasing activities have access to the second user interface that is used for rating a supplier. Therefore, a supplier can be rated by many users/purchasers. Purchasers can perform ad hoc rating of a supplier via the second user interface before and meanwhile performing a purchasing activity. Suppliers also have access to supplier rating analyses. The first, second, and third user interfaces can be made available over the Internet, Intranet, or Extranet. For a more secured approach, the first, second, and third user interfaces can be provided over Intranet or Extranet, which restricts access to employees of purchasing and supplying companies.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

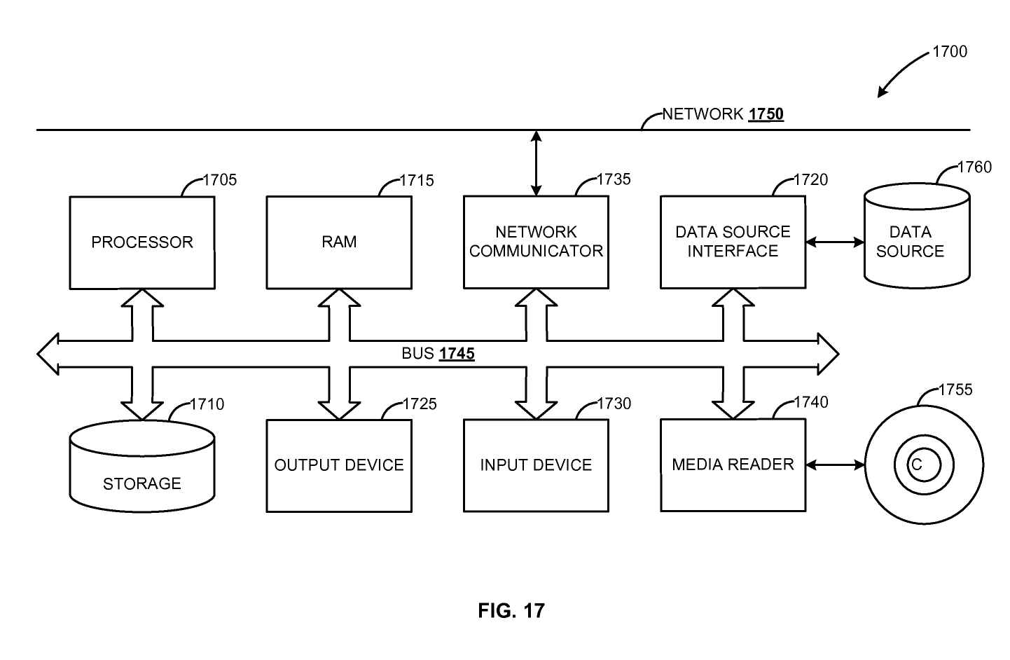

FIG. 17 is a block diagram of an exemplary computer system 1700. The computer system 1700 includes a processor 1705 that executes software instructions or code stored on a computer readable storage medium 1755 to perform the above-illustrated methods of the invention. The computer system 1700 includes a media reader 1740 to read the instructions from the computer readable storage medium 1755 and store the instructions in storage 1710 or in random access memory (RAM) 1715. The storage 1710 provides a large space for keeping static data where at least some instructions could be stored for later execution. The stored instructions may be further compiled to generate other representations of the instructions and dynamically stored in the RAM 1715. The processor 1705 reads instructions from the RAM 1715 and performs actions as instructed. According to one embodiment of the invention, the computer system 1700 further includes an output device 1725 (e.g., a display) to provide at least some of the results of the execution as output including, but not limited to, visual information to users and an input device 1730 to provide a user or another device with means for entering data and/or otherwise interact with the computer system 1700. Each of these output devices 1725 and input devices 1730 could be joined by one or more additional peripherals to further expand the capabilities of the computer system 1700. A network communicator 1735 may be provided to connect the computer system 1700 to a network 1750 and in turn to other devices connected to the network 1750 including other clients, servers, data stores, and interfaces, for instance. The modules of the computer system 1700 are interconnected via a bus 1745. Computer system 1700 includes a data source interface 1720 to access data source 1760. The data source 1760 can be accessed via one or more abstraction layers implemented in hardware or software. For example, the data source 1760 may be accessed by network 1750. In some embodiments the data source 1760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
in response to a selection, provide a first user interface to a purchaser, wherein the first user interface comprises one or more supplier analysis options;
in response to selection of one or more of the options on the first user interface, generate and display a supplier rating analysis using supplier evaluation data provided by a plurality of purchasers and stored in a data source;
based on a purchasing activity, provide a second user interface to the purchaser, wherein the second user interface comprises one or more input fields to capture the evaluation data from the purchaser, the one or more input fields comprise supplier rating-level fields and supplier rating-criteria fields;
receive the evaluation data after input by the purchaser; and
store the evaluation data received from the purchaser in the data source.

2. The article of manufacture of claim 1, wherein the supplier rating analysis comprises one or more of a table and a graphical representation and one or more drill down options.

3. The article of manufacture of claim 1, wherein a link to the first user interface is published on a social networking webpage and the first user interface is provided following the selection of the link.

4. The article of manufacture of claim 1, wherein the purchasing activity comprises an activity performed by the purchaser during the course of a purchasing process.

5. The article of manufacture of claim 1, wherein the one or more input fields further comprise a supplier identification field.

6. The article of manufacture of claim 1, further comprising instructions, which when executed by a computer, cause the computer to:
in response to a selection by the supplier, provide a third user interface to the supplier, wherein the third user interface comprises the one or more supplier analysis options; and
in response to selection of one or more of the options on the third user interface, generate and display the supplier rating analysis using the supplier evaluation data provided by the plurality of purchasers and stored in the data source.

7. The article of manufacture of claim 6, wherein the third user interface comprises one or more options to drill down the supplier rating analysis and the supplier rating analysis comprises one or more of a table and a graphical representation.

8. A computerized method for supplier rating and reporting, the method comprising:
in response to a selection, providing a first user interface to a purchaser, wherein the first user interface comprises one or more supplier analysis options;
in response to selection of one or more of the options on the first user interface, generating and displaying a supplier rating analysis using supplier evaluation data provided by a plurality of purchasers and stored in a data source;
based on a purchasing activity, providing a second user interface to the purchaser, wherein the second user interface comprises one or more input fields to capture the evaluation data from the purchaser, the one or more input fields comprise supplier rating-level fields and supplier rating-criteria fields;
receiving the evaluation data after input by the purchaser; and
storing the evaluation data received from the purchaser in the data source.

9. The method of claim 8, wherein the supplier rating analysis comprises one or more of a table and a graphical representation and one or more drill down options.

10. The method of claim 8, wherein a link to the first user interface is published on a social networking webpage and the first user interface is provided following the selection of the link.

11. The method of claim 8, wherein the purchasing activity comprises an activity performed by the purchaser during the course of a purchasing process.

12. The method of claim 8, wherein the one or more input fields further comprise a supplier identification field.

13. The method of claim 8, further comprising:
in response to a selection by the supplier, providing a third user interface to the supplier, wherein the third user interface comprises the one or more supplier analysis options; and
in response to selection of one or more of the options on the third user interface, generating and displaying the supplier rating analysis using the supplier evaluation data provided by the plurality of purchasers and stored in the data source

14. The method of claim 13, wherein the third user interface comprises one or more options to drill down the supplier rating analysis and the supplier rating analysis comprises one or more of a table and a graphical representation.

15. A computer system for supplier rating and reporting, comprising:
a computer memory to store program code; and
a processor to execute the program code to:
in response to a selection, provide a first user interface to a purchaser, wherein the first user interface comprises one or more supplier analysis options;
in response to selection of one or more of the options on the first user interface, generate and display a supplier rating analysis using supplier evaluation data provided by a plurality of purchasers and stored in a data source;
based on a purchasing activity, provide a second user interface to the purchaser, wherein the second user interface comprises one or more input fields to capture the evaluation data from the purchaser, the one or more input fields comprise supplier rating-level fields and supplier rating-criteria fields;
receive the evaluation data after input by the purchaser; and
store the evaluation data received from the purchaser in the data source.

16. The system of claim 15, wherein the supplier rating analysis comprises one or more of a table and a graphical representation and one or more drill down options.

17. The system of claim 15, wherein a link to the first user interface is published on a social networking webpage and the first user interface is provided following the selection of the link.

18. The system of claim 15, wherein the purchasing activity comprises an activity performed by the purchaser during the course of a purchasing process.

19. The system of claim 15, wherein the one or more input fields further comprise a supplier identification field.

20. The system of claim 15, wherein the processor further executes the program code to:
in response to a selection by the supplier, provide a third user interface to the supplier, wherein the third user interface comprises the one or more supplier analysis options; and
in response to selection of one or more of the options on the third user interface, generate and display the supplier rating analysis using the supplier evaluation data provided by the plurality of purchasers and stored in the data source, wherein the third user interface comprises one or more options to drill down the supplier rating analysis and the supplier rating analysis comprises one or more of a table and a graphical representation.
